(19) United States
(12) Patent Application Publication
(10) Pub. No.: US 2011/0212010 A1
(43) Pub. Date: Sep. 1, 2011

(54) Apparatus and Method for Thermal Destruction of Volatile Organic Compounds

(75) Inventor: Jeffry A. Bell, Lakeville, MN (US)

(73) Assignee: DESPATCH INDUSTRIES LIMITED PARTNERSHIP, Lakeville, MN (US)

(21) Appl. No.: 12/874,721

(22) Filed: Sep. 2, 2010

Related U.S. Application Data
(60) Provisional application No. 61/239,246, filed on Sep. 2, 2009.

(51) Int. Cl. B01D 53/72; F27B 9/06; H05B 1/02; H05B 3/00

(52) U.S. Cl. 423/245.3; 219/388; 392/465; 392/491; 219/494; 219/201

(57) ABSTRACT

A thermal oxidizer assembly is adapted for mounting onto a furnace, such that a heating chamber of the assembly is in direct flow-through communication with an interior of the furnace and defines a flow path for volatile organic compounds that are released from workpieces being processed within the furnace. A heating module is mounted within the heating chamber of the assembly and is located within the flow path to create turbulent flow therethrough. The assembly is configured to allow a natural draft to pull the volatile organic compounds from the furnace and through the flow path, and the heating module heats the volatile organic compounds, within the heating chamber, to a temperature necessary to destroy greater than approximately 99% of the volatile organic compounds. A flow rate of the volatile organic compounds being pulled along the flow path is, preferably, between approximately five and thirty standard cubic feet per minute.

### RELATED APPLICATION

This application claims the benefit of U.S. Provisional Patent Application No. 61/239,246, filed Sep. 2, 2009, the contents of which are hereby incorporated by reference.

### FIELD OF THE INVENTION

The present disclosure pertains to the destruction, via thermal oxidation, of volatile organic compounds emitted from workpieces, for example, being processed in a furnace.

### BACKGROUND

Thermal processing, for example, drying and/or curing, of workpieces/materials that include solvents can release volatile organic compounds (VOC's). Such thermal processing may be accomplished in an oven or a furnace, for example, like that described in commonly assigned U.S. Pat. No. 7,514,650. A commercially available furnace of this type is the Despatch Continuous Infrared Furnace (available from Despatch Industries, Minneapolis, Minn.). VOC's are classified as environmental pollutants and their emissions from facilities are subject to regulation at both the state and federal level.

Typically, gases, which are laden with the VOC's released during thermal processing in ovens/furnaces of industrial facilities, are directed through a series or system of ductwork to one or more large facility-wide oxidizers, or incinerators. Relatively large blowers may be required to move the gases through the ductwork and the oxidizers at flow rates of up to about 1,000 standard cubic feet per minute (SCFM). Condensation may occur, as the VOC's travel through the ductwork and away from the oven/furnace, so that condensed VOC's, which have accumulated in the system, over time, must be collected for proper disposal. Some facilities employ condensers to collect VOC's closer to the point of origination, yet condensers require waste collection and disposal, as well as regular cleaning. Thus, there is a need for new apparatus and methods for more efficient thermal destruction of VOC's.

### BRIEF DESCRIPTION OF THE DRAWINGS

The following drawings are illustrative of particular embodiments of the invention and therefore do not limit the scope of the invention. The drawings are not to scale (unless so stated) and are intended for use in conjunction with the explanations in the following detailed description. Embodiments of the invention will hereinafter be described in conjunction with the appended drawings, wherein like numerals denote like elements.

FIG. 1 is a side elevation view, with a partial cut-away section, of an exemplary drying furnace in which a pair of thermal oxidizer assemblies are employed, according to some embodiments of the present invention.

FIG. 2 is a side elevation view, including electronic control schematics, of a thermal oxidizer assembly, according to some embodiments.

FIG. 3 is a perspective view of a heating module for a thermal oxidizer assembly, according to some embodiments of the present invention.

FIG. 4 is a schematic depicting lead wire connections for the heating module shown in FIG. 3, according to some embodiments.

### SUMMARY

Embodiments of the present invention provide equipment for efficiently destroying VOCs in close physical and temporal proximity to where/when such VOCs are generated, with the equipment including an insulated sidewall for mounting to a furnace, a heating module, and an exhaust portion. In a first aspect, the invention provides a thermal oxidizer assembly that includes an insulated sidewall, a heating module, and an exhaust portion. The insulated sidewall can surround a heating chamber. The insulated sidewall can be adapted for mounting directly onto a furnace such that the heating chamber is in direct flow-through communication with an interior of the furnace and defines a flow path. The heating module can be mounted within a heating chamber. The heating chamber can be located within the flow path defined by the heating chamber. The exhaust portion can extend from an upper section of the heating chamber. The exhaust portion can be configured to allow a natural draft to pull gases from the furnace and through the flow path defined by the heating chamber. Some preferred embodiments include one or more of the following features. The heating module can extend along a lower section of an overall vertical height of the heating chamber. A length of the lower section of the overall vertical height of the heating chamber, along which the heating module extends, can be between approximately one half and approximately two thirds of the overall vertical height. The heating module can span a horizontal cross-sectional area of the heating chamber. The heating module can be removable, as a cohesive unit, from the assembly for replacement of the heating module and/or maintenance of the heating module and/or heating chamber. The heating module can include an array of heating elements. Each heating element of the array can be formed from a coiled wire and oriented so that the flow path extends through a coil inner diameter and along a length of each coiled wire heating element. Some thermal oxidizer assemblies include means for assisting the natural draft (e.g., a venturi stack). Some thermal oxidizer assemblies include at least one temperature sensor mounted in the heating chamber at a location just above the heating module. In some such embodiments, signals from the at least one temperature sensor provide feedback control to the heating module for heating the gases within the heating chamber.

Additional features that can be incorporated into some embodiments are articulated as follows. The overall height of the heating chamber can be approximately forty-four inches. The horizontal cross-sectional area of the heating chamber can be approximately constant along the length of the overall height of the heating chamber at approximately fifty-five square inches. In embodiments having a coiled wire heating element, the length of each coiled wire heating element can extend vertically along a lower section of the overall vertical height of the heating chamber. In some such embodiments, the array of coiled wire heating elements spans a horizontal cross-sectional area of heating chamber. In embodiments having an array of heating elements, the array of heating elements can be mounted in an insulative framework. In some such embodiments, the insulative framework can span a horizontal cross-sectional area of the heating chamber. In some such embodiments, the insulative framework can include a plurality of tiers, with each tier including an array of holes. In some such embodiments, each coiled wire heating element of the array of heating elements can extend through a corresponding hole of each tier. In some such embodiments, the array of heating elements and the insulative framework form a cohesive unit that can be removed from the assembly for replacement of the heating module and/or maintenance of the heating module and/or the heating chamber. In some embodiments, a flow rate of the heated gases being pulled along the flow path defined by the heating chamber can be between approximately five standard cubic feet per minute and approximately thirty standard cubic feet per minute. In some such embodiments, the flow rate can be between approximately ten standard cubic feet per minute and approximately twenty standard cubic feet per minute.

In a second aspect, the invention provides a method for destroying volatile organic compounds that are emitted from workpieces being processed in a furnace. The method can include providing a flow path. Turbulent flow can be created by positioning a heating module in the flow path. The method can include allowing a natural draft to pull the volatile organic compounds from the furnace and along the flow path. The method can include heating the volatile organic compounds in the flow path, via the heating module, to a temperature necessary to destroy greater than approximately 99% of the volatile organic compounds.

Some preferred embodiments include one or more of the following features. The method can include controlling the natural draft such that a flow rate at which the volatile organic compounds are pulled along the flow path is between approximately five standard cubic feet per minute and approximately thirty standard cubic feet per minute. The flow path can be a first flow path positioned in proximity to an inlet of the furnace. In some such embodiments, the heating module positioned in the first flow path can be a first heating module. In some such embodiments, the VOCs are a first portion of VOCs. In some such embodiments, the method can include providing a second flow path at an outlet of the furnace in which turbulent flow is created by positioning of a second heating module therein. In some such embodiments, the method can include allowing a natural draft to pull a second portion of VOCs from the furnace and along the second flow path. In some such embodiments, the method can include heating the second portion of volatile organic compounds in the second flow path, via the second heating module, to a temperature necessary to destroy greater than approximately 99% of the second portion of volatile organic compounds.

In a third aspect, the invention provides a furnace for processing workpieces that release VOCs during the processing. The furnace can include a processing chamber through which the workpieces are conveyed from an inlet to an outlet thereof. The furnace can include at least one heating chamber in direct flow-through communication with the processing chamber. Each of the at least one heating chamber can define a flow path for the VOCs that are released from the workpieces being processed in the processing chamber. The furnace can include a heating module mounted within each of the at least one heating chamber. The heating module can be located within the corresponding flow path to create turbulent flow therethrough. The heating module heating the VOCs to a temperature necessary to destroy greater than 99% thereof. The furnace can include an exhaust portion extending from an upper section of each of the at least one heating chamber. The exhaust portion can be configured to allow a natural draft to pull the VOCs from the processing chamber and through the flow path defined by each of the at least one heating chamber. The exhaust portion can include an exhaust hood connecting the furnace to exhaust ductwork of a facility in which the furnace is employed.

In some embodiments, the at least one heating chamber can include a first heating chamber and a second heating chamber. The first heating chamber can be located in proximity to the inlet of the processing chamber. The second heating chamber can be located in proximity to the outlet of the processing chamber.

Any of the aspects set forth in the Summary section can incorporate any of the features set forth in the Summary section.

### DETAILED DESCRIPTION

The following detailed description is exemplary in nature and is not intended to limit the scope, applicability, or configuration of the invention in any way. Rather, the following description provides practical illustrations for implementing exemplary embodiments of the invention.

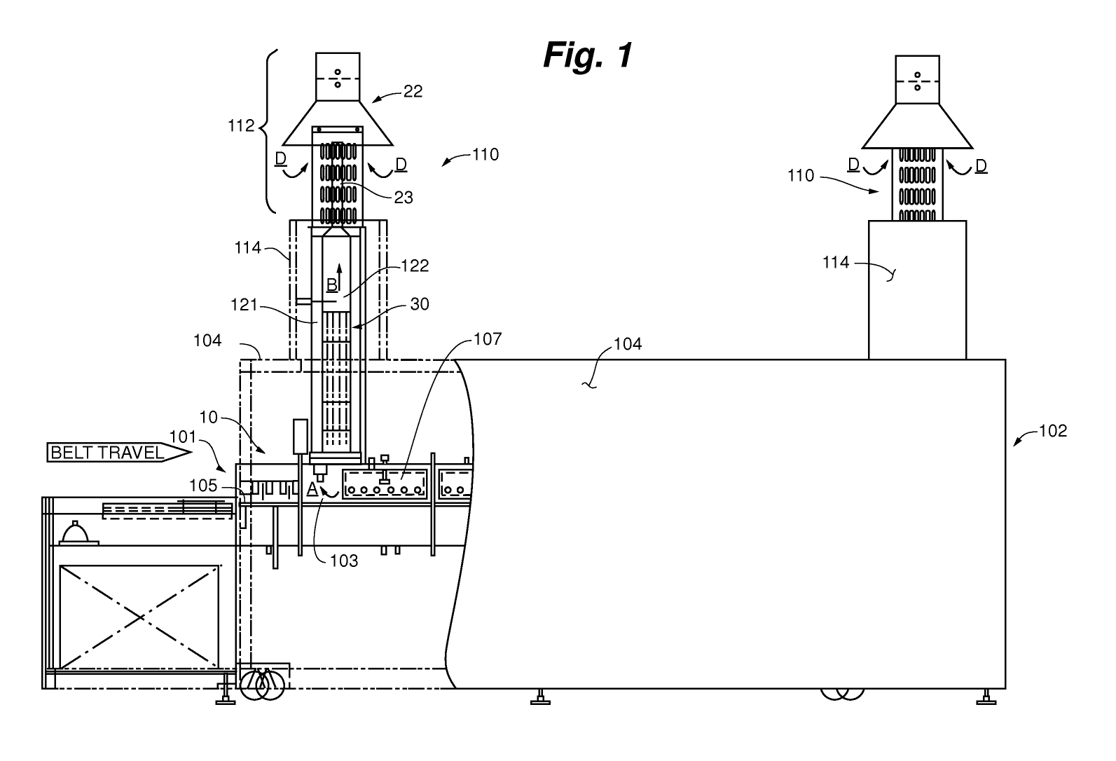

FIG. 1 is a side elevation view, with a partial cut-away section, of an exemplary furnace 10 in which a pair of thermal oxidizer assemblies 110 are employed, according to some embodiments of the present invention. FIG. 1 illustrates furnace 10 as a continuous infrared furnace, which employs infrared lamps 107 to cure workpieces that are conveyed through a processing chamber 103 of the furnace, from an inlet 101 thereof to an outlet 102 thereof, by a conveyor 105. It should be noted that other types of furnaces/ovens, which are known in the art, may employ thermal oxidizer assemblies according to embodiments of the present invention. Although two thermal oxidizer assemblies 110 for furnace 10 are preferred, for example, to maintain greater conveyor speeds, a single thermal oxidizer assembly 110 may be employed in some alternate embodiments; and, according to yet further alternate embodiments, more than two thermal oxidizer assemblies 110 may be employed by a furnace. Furthermore, it is contemplated that thermal oxidizer assembly 110 may be incorporated in other types of VOC-emitting apparatus known in the art.

FIG. 1 further illustrates one of the pair of thermal oxidizer assemblies 110 mounted to furnace 10 in proximity to inlet 101 of chamber 103 and the other in proximity to outlet 102 of chamber 103, and each being surrounded by an optional guard 114 that is attached to a housing 104 of furnace 10; each oxidizer assembly 110 includes an insulated sidewall 121 that surrounds a heating chamber 122, which is in direct flow through communication with an interior of furnace 10, via a direct connection (shown in proximity to arrow A), for example, formed by a one inch by ten inch slot; an exhaust portion 112 of each oxidizer assembly 110 is shown extending upward from the corresponding heating chamber 122. Sidewall 121 may be formed from an aluminum casing which is lined with an alumina/silica insulation.

Locating the thermal oxidizer assemblies 110 in close proximity to the furnace 10 can provide significant advantages. Destroying VOCs closer to where they are generated and soon after they are generated reduces the damage that such VOCs can cause. For instance, if VOC-laden gas must travel any distance through one or more pipes to VOC-destruction equipment, inevitably some of the VOCs will condense within the pipe(s). In such instances, the condensed VOCs must be removed from the pipe(s) through costly and labor-intensive processes. Another danger faced by systems that transport VOC-laden gas from the furnace 10 to VOC-destruction equipment is that the VOCs can drip back into the furnace 10 and cause a fire. Embodiments of the present invention, such as those shown in the Figures, locate the thermal oxidizer assemblies 110 significantly closer to where the VOCs are generated than existing systems.

According to the illustrated embodiment, exhaust portion 112 is configured to allow a natural draft (i.e. chimney effect) to draw gas laden with volatile organic compounds (VOC's), emitted from the workpieces being processed in furnace 10, up through heating chamber 122; and a heating module 30 is mounted within heating chamber 122 to heat the VOC-laden gas to a temperature necessary to destroy (i.e. combust or oxidize) greater than approximately 99% of the VOC's. Heating module 30 is shown located within a flow path defined by chamber 122, for example, between arrow A and arrow B, so as to create turbulent flow therethrough. According to some preferred embodiments, heating module 30, in conjunction with the heat released by the oxidation process, maintains a temperature of approximately 760° C. within heating chamber 122, and a venturi stack 23 assists the natural draft in drawing the VOC-laden gas through the heating chamber at a flow rate between approximately five standard cubic feet per minute (SCFM) and approximately thirty SCFM, preferably between approximately ten and twenty SCFM. According to some alternate embodiments, the natural draft may be damper-controlled, for example, either via a manual or a pressure switch controlled damper mechanism located between heating module 30 and the interior of furnace 10, or the natural draft may be completely unassisted. In most embodiments, no fan is needed to encourage VOC-laden gas from the furnace 10 into the thermal oxidizer assemblies 110. Fanless systems can be advantageous, as fans require energy input and regular maintenance, among other advantages.

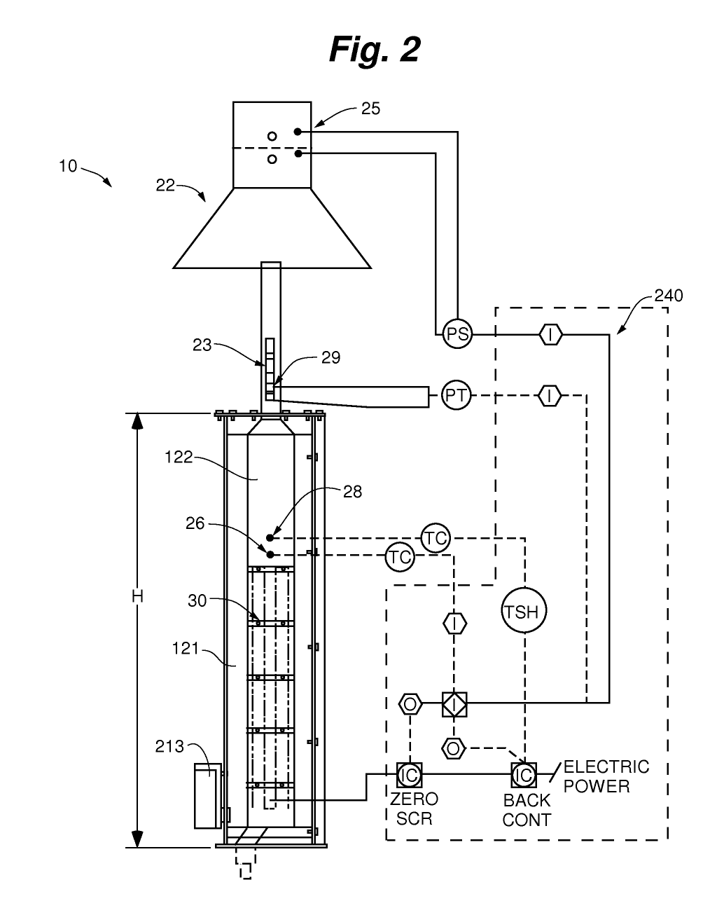

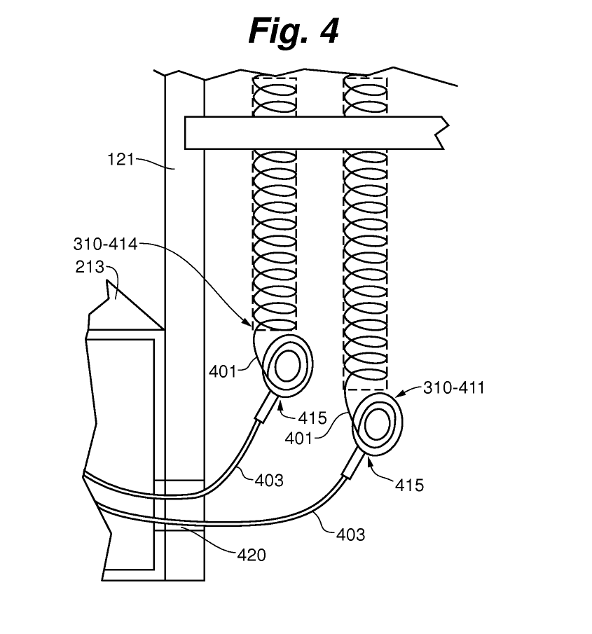

With further reference to FIG. 1, exhaust portion 112 may further include an exhaust hood 22 to connect with exhaust ductwork of a facility in which furnace 10 is employed. According to some preferred embodiments, each exhaust duct that extends from the corresponding hood 22 requires 200 cubic feet per minute (5.5 cubic meters/minute) of facility exhaust, and has a diameter of approximately 5.75 inches (150 mm) for connection to facility ductwork. Entrainment of relatively cool ambient air, per arrows D, will reduce a temperature of the exhaust entering hood 22 to approximately 200° C. Turning now to FIG. 2, electronic controls for thermal oxidizer assemblies 110, according to some embodiments, will be described. FIG. 2 is a side elevation view, including electronic control schematics, of one of thermal oxidizer assemblies 110, according to some embodiments. FIG. 2 illustrates a first temperature sensor 26 being mounted within heating chamber 122, just above heating module 30, in order to monitor and provide feedback for control of heating module 30. According to some preferred embodiments, sensor 26 works in conjunction with a heating circuit, that is, preferably remotely mounted, and which includes an electronic temperature controller 240 and a solid state or mechanical means of metering power to heating module 30. A heater lead tube or passageway 420 (FIG. 4) may extend from within a junction box 213 and through sidewall 121 of oxidizer assembly 110 to provide for electrical coupling to heating module 30, as will be described in greater detail below. FIG. 2 further illustrates a second temperature sensor 28, which is mounted in proximity to first sensor 26 and which serves as a redundant, or over-temperature sensor, working in conjunction with a limit controller to ensure that a safe temperature within heating chamber 122 is not exceeded; a high limit set point may be 840° C., at which power to the heating circuit is interrupted by the limit controller. Temperature sensors 26, 28 may be thermocouples or resistance temperature devices (RTD), or any other suitable type of temperature sensor known to those skilled in the art.

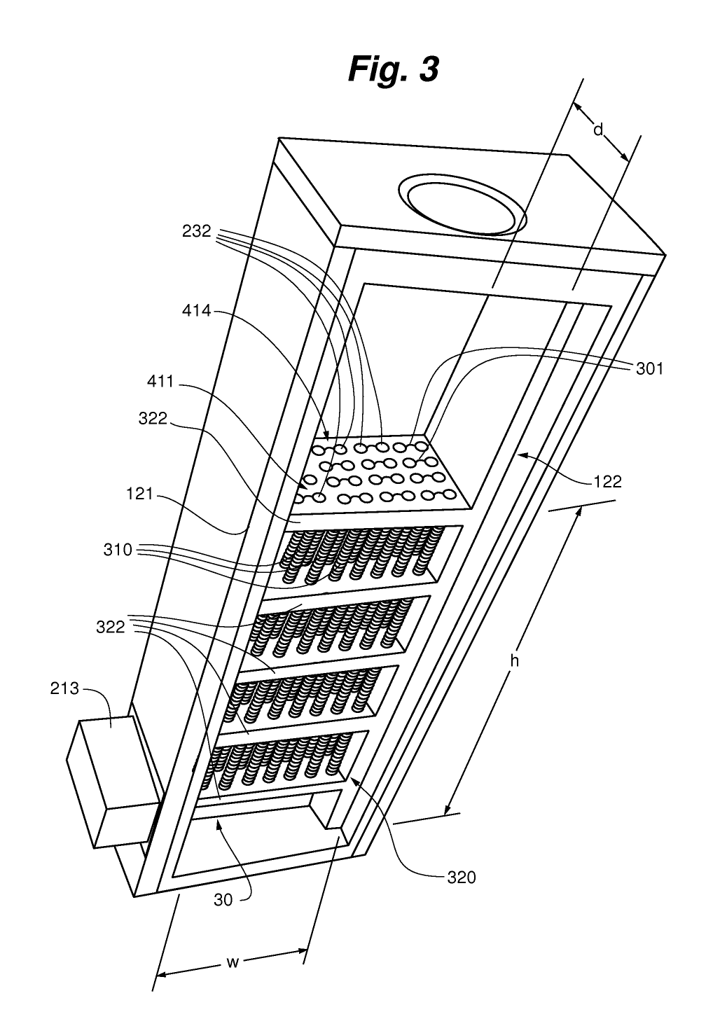

With further reference to FIG. 2, in order to detect if flow is impeded, flow out from heating chamber 122 is monitored at velocity pressure ports 29 of venturi stack 23, which may be coupled to a pressure transducer or a pressure switch. According to an exemplary embodiment, venturi stack 23 receives injection of compressed clean dry air or nitrogen, for example, at a flow rate between 10 and 100 standard cubic feet per hour. FIG. 2 further illustrates a pressure switch 25 mounted in exhaust hood in order to ensure that the main facility exhaust is operating, prior to allowing operation of oxidizer assembly 110, so that hot exhaust is not released into the ambient atmosphere. FIG. 3 is a perspective view of heating module 30, within heating chamber 122, according to some embodiments of the present invention. FIG. 3 illustrates heating module 30 including an array of heating elements 310 and an insulative framework 320 having tiers 322 in which elements 310 are mounted. Each heating element 310 is shown being formed as a coiled wire that extends through a corresponding hole 232 of each of tiers 322. In many embodiments, the heating elements 310 are gasless, with electricity providing the input energy rather than gas, which can provide a variety of advantages. According to the illustrated embodiment, framework 320 includes five tiers 322 and each of tiers 322 includes a four by eight array of thirty-two holes 232 in order to support thirty-two heating elements 310, which are coupled to one another in series, for example, via welded junctions with jumper wires 301. Framework 320 may be formed from a reinforced silica matrix composite, and, according to alternate embodiments, framework 320 may include more or less tiers 322, that that illustrated, and/or different arrays of holes 232 may be employed. A height h of framework 320 may range from approximately 24 inches to approximately 28 inches, a width w from approximately 8 inches to approximately 14 inches, and a depth d from approximately 4 inches to approximately 6 inches. It should be noted that alternate geometries of module 30, for example, cylindrical, may be employed by alternate embodiments. According to an exemplary embodiment, each coiled wire heating element 310 has an outer diameter of approximately ¾ inch and is formed from a heavy gauge nickel chromium wire, for example, having a diameter between approximately 0.09 inch and approximately 0.13 inch; and, each of the thirty-two heating elements 310 are assembled into framework 320 such that: a first section of each element 310, which extends from below the lowermost of tiers 322 to the second lowest of tiers 322, is stretched to a first length of approximately 8.2 inches (6% under stretch), so that the first section has a resistance of approximately 0.26 ohms; and a second section of each element 310, which extends from the second lowest of tiers 322 to the uppermost of tiers 322, is stretched to a length of approximately 16.25 inches (33% over stretch), so that the second section has a resistance of approximately 0.37 ohms. Thus, heating is preferential near the lower end of module 30, for example, to avoid over-heating near the upper end of module 30. According to some preferred embodiments, a single phase voltage of approximately 400V is applied across the above-described exemplary embodiment of the series-connected heating elements 310, for example, via lead wire connections (like those shown in FIG. 4), which results in a current of between approximately sixteen and twenty amps, in order to achieve a total wattage of approximately 7.5 kW, and a watt density of approximately 6 W/square inch.

FIG. 4 is a schematic depicting lead wire connections for heating module 30, according to some embodiments. As previously described, elements 310 of module 30 are connected to one another in series, and, thus, extend between two terminal ends 310-411, 310-414, which may be located on a front row 411 and a back row 414 (FIG. 3), respectively, of the array of heating elements 310, and at the end of rows 411, 414 that are in closest proximity to junction box 213. FIG. 4 illustrates lead wires 403, that extend from junction box 213, through heater lead tube or passageway 420, being coupled to respective loops 401, that are formed in terminal ends 310-411, 310-414 of the series-connected heating elements 310. According to the illustrated embodiment, a ring terminal 415, for example, being crimped to each of lead wires 403, forms an interface for the coupling between each loop 401 and the corresponding lead wire 403. According to some preferred embodiments, a nut and bolt connection is formed between each ring terminal 415 and the corresponding loop 401 to complete and secure the electrical coupling of heating module 30.

With reference back to FIG. 2, mounted heating module 30 extends along a lower section of an overall height H of heating chamber 122, which lower section has a length which is preferably between approximately one half and two thirds of the overall vertical height. According to some preferred embodiments, heating module 30 spans a horizontal cross-section of heating chamber 122, and each coiled wire heating element 30 is oriented so that an inner diameter of each forms part of the flow path through which the VOC-laden gas is drawn. According to an exemplary embodiment, overall height H is approximately forty-four inches and the horizontal cross-sectional area of heating chamber 122 is approximately fifty-five square inches. As previously mentioned, locating heating module 30 within the flow path creates turbulent flow; the turbulent flow facilitates more effective heat exchange between heating elements 310 and the gas so that heating elements 310 can operate at the temperature necessary to combust/destroy greater than 99% of the VOC's in the gas, at the aforementioned flow rates (approximately 5 SCFM-30 SCFM), without overheating, thereby increasing longevity of heating module 30.

Referring again to FIG. 1, in many embodiments, the thermal oxidizer assemblies 110 can be significantly smaller than conventional incinerators. Such relatively small configurations have much smaller footprints than conventional incinerators, permitting placement of the thermal oxidizer assemblies 110 in a wider variety of locations on the manufacturing floor. In many instances, this flexibility of location enables the thermal oxidizer assemblies 110 to be located in close proximity to the furnace 10 itself, thereby minimizing the physical distance between where the VOCs are generated and where they are destroyed. As noted above, this can provide a significant advantage in many embodiments of the present invention. Additionally, such relatively small configurations typically require less energy input than conventional incinerators.

Finally, with further reference to FIGS. 1-3, it may be appreciated that the illustrated design of heating module 30 allows module 30 to be removed from heating chamber 122 as a cohesive unit, for example, via removable panels and/or doors formed in optional guard 114 and insulated sidewall 121. Such removal can allow for a quick exchange of a ‘spent’ heating module for a new heating module and/or for other maintenance of thermal oxidizer assembly 110 with minimal downtime for furnace 10. In the foregoing detailed description, the invention has been described with reference to specific embodiments. However, it may be appreciated that various modifications and changes can be made without departing from the scope of the invention as set forth in the appended claims.

1. A thermal oxidizer assembly comprising:
an insulated sidewall surrounding a heating chamber and being adapted for mounting directly onto a furnace such that the heating chamber is in direct flow-through communication with an interior of the furnace and defines a flow path;
a heating module mounted within the heating chamber, the heating module being located within the flow path defined by the heating chamber; and
an exhaust portion extending from an upper section of the heating chamber, the exhaust portion being configured to allow a natural draft to pull gases from the furnace and through the flow path defined by the heating chamber.

2. The assembly of claim 1, wherein the heating module extends along a lower section of an overall vertical height of the heating chamber.

3. The assembly of claim 2, wherein a length of the lower section of the overall vertical height of the heating chamber, along which the heating module extends, is between approximately one half and approximately two thirds of the overall vertical height.

4. The assembly of claim 3, wherein the heating module spans a horizontal cross-sectional area of the heating chamber.

5. The assembly of claim 1, wherein the heating module spans a horizontal cross-sectional area of the heating chamber.

6. The assembly of claim 1, wherein the heating module is removable, as a cohesive unit, from the assembly for replacement of the heating module and/or maintenance of the heating module and/or heating chamber.

7. The assembly of claim 1, wherein the heating module comprises an array of heating elements, each heating element of the array being formed from a coiled wire and being oriented so that the flow path extends through a coil inner diameter and along a length of each coiled wire heating element.

8. The assembly of claim 1, further comprising means for assisting the natural draft.

9. The assembly of claim 8, wherein the means for assisting the natural draft comprises a venturi stack.

10. The assembly of claim 1, further comprising at least one temperature sensor mounted in the heating chamber at a location just above the heating module; and wherein signals from the at least one temperature sensor provide feedback control to the heating module for heating the gases within the heating chamber.

11. A method for destroying volatile organic compounds that are emitted from workpieces being processed in a furnace, the method comprising:
providing a flow path in which turbulent flow is created by positioning of a heating module therein;
allowing a natural draft to pull the volatile organic compounds from the furnace and along the flow path; and
heating the volatile organic compounds, in the flow path, via the heating module, to a temperature necessary to destroy greater than approximately 99% of the volatile organic compounds.

12. The method of claim 11, further comprising controlling the natural draft such that a flow rate at which the volatile organic compounds are pulled along the flow path is between approximately five standard cubic feet per minute and approximately thirty standard cubic feet per minute.

13. The method of claim 11, wherein the flow path is a first flow path positioned in proximity to an inlet of the furnace, the heating module positioned in the first flow path is a first heating module, and the volatile organic compounds are a first portion of volatile organic compounds; and further comprising:
providing a second flow path at an outlet of the furnace in which turbulent flow is created by positioning of a second heating module therein;
allowing a natural draft to pull a second portion of volatile organic compounds from the furnace and along the second flow path; and
heating the second portion of volatile organic compounds, in the second flow path, via the second heating module, to a temperature necessary to destroy greater than approximately 99% of the second portion of volatile organic compounds.

14. A furnace for processing workpieces that release volatile organic compounds during the processing, the furnace comprising:
a processing chamber through which the workpieces are conveyed from an inlet to an outlet thereof;
at least one heating chamber in direct flow-through communication with the processing chamber, each of the at least one heating chamber defining a flow path for the volatile organic compounds that are released from the workpieces being processed in the processing chamber;
a heating module being mounted within each of the at least one heating chamber and located within the corresponding flow path to create turbulent flow therethrough, the heating module heating the volatile organic compounds to a temperature necessary to destroy greater than 99% thereof; and
an exhaust portion extending from an upper section of each of the at least one heating chamber and being configured to allow a natural draft to pull the volatile organic compounds from the processing chamber and through the flow path defined by each of the at least one heating chamber, the exhaust portion including an exhaust hood connecting the furnace to exhaust ductwork of a facility in which the furnace is employed.

15. The furnace of claim 14, wherein the at least one heating chamber comprises a first heating chamber and a second heating chamber, the first heating chamber being located in proximity to the inlet of the processing chamber, and the second heating chamber being located in proximity to the outlet of the processing chamber.

16. The furnace of claim 14, wherein the heating module spans a horizontal cross-sectional area of the respective heating chamber.

17. The furnace of claim 14, wherein the heating module is removable, as a cohesive unit, from the corresponding heating chamber for replacement of the heating module and/or maintenance of the furnace.

18. The furnace of claim 14, wherein the heating module comprises an array of heating elements, each heating element of the array being formed from a coiled wire and being oriented so that the flow path extends through a coil inner diameter and along a length of each coiled wire heating element.

19. The furnace of claim 18, wherein:
the length of each coiled wire heating element extends vertically along a lower section of the overall vertical height of the corresponding heating chamber; and
the array of coiled wire heating elements spans a horizontal cross-sectional area of the corresponding heating chamber.

20. The furnace of claim 18, wherein the array of heating elements is mounted in an insulative framework.

21. The furnace of claim 20, wherein:
the insulative framework includes a plurality of tiers, each tier including an array of holes; and
each coiled wire heating element of the array of heating elements extends through a corresponding hole of each tier.

22. The furnace of claim 14, further comprising at least one temperature sensor mounted in each of the at least one heating chamber at a location just above the corresponding heating module; and wherein signals from the at least one temperature sensor provide feedback control to the heating module for heating the volatile organic compounds within the heating chamber.
